(19) United States
(12) Patent Application Publication
(10) Pub. No.: US 2010/0257242 A1
(43) Pub. Date: Oct. 7, 2010

(54) Methods, Systems, And Computer Program Products For Providing A Mashup Using A Pub/Sub Tuple

(76) Inventor: Robert P. Morris, Raleigh, NC (US)

Correspondence Address: SCENERA RESEARCH, LLC, 5400 Trinity Road, Suite 303, Raleigh, NC, 27607, US

(21) Appl. No.: 12/417,377

(22) Filed: Apr. 2, 2009

(51) Int. Cl. G06F 15/16; G06F 9/46; G06F 17/30

(52) U.S. Cl. 709/206; 719/330; 707/E17.044

(57) ABSTRACT

Methods and systems are described for providing a mashup using a pub/sub tuple. In one aspect, mashup information identifying a content provider and having subscription information for creating a subscription to an existing pub/sub tuple is received. A mashup pub/sub tuple is created including a first element including information for obtaining first content from the existing pub/sub tuple based on the subscription information and a second element including information for obtaining second content from the identified content provider. A pub/sub principal is subscribed to the mashup pub/sub tuple. The first content and the second content is provided to the pub/sub principal pursuant to the subscription to the mashup pub/sub tuple.

### BACKGROUND

A “mashup” is a combination of data from multiple sources combined for a specific purpose. Mashups have been conventionally implemented as Web applications that combine data from one or more sources. One example of a mashup is the use of cartographic data from GOOGLE MAPS to add location information to real estate data, thereby creating a new and distinct Web service that was not originally provided by either source.

Mashups have conventionally accomplished integration through the use of application programming interfaces (APIs) to tap data sources to access raw source data and through the use of specific applications to produce specific results out of combinations of the raw source data. Although one can appreciate the many benefits afforded through the use of mashups, the requirement for specialized programming and APIs has slowed the spread of mashups. In addition, the use of request/response protocols, such as hypertext transfer protocol (HTTP), for accessing all data sources has made mashup implementation even more complex.

An alternative mode of exchanging information over the Internet, or another network, is to use a publish/subscribe (“pub/sub”), asynchronous, communication protocol. The commands of an asynchronous protocol, such as a pub/sub communication protocol, are structured such that there need not be a one-to-one correspondence between messages exchanged between communication entities. In some cases a publisher of information via the protocol need not wait for, nor expect, a response from a receiver of a message. Moreover, a receiver need not send a request for each message received. That is, a receiver may receive multiple messages associated with a sent message and/or may receive an unsolicited message. Thus, unlike a request/response, synchronous protocol where the response is sent directly (synchronously) and only in response to the entity's request, the information can instead be sent to a receiver in the absence of a corresponding request from the receiver (i.e., asynchronous to any request for information).

According to pub/sub communication protocols, a pub/sub service can receive published information from a publisher and asynchronously deliver such information to receivers. Typically, the pub/sub service stores and organizes such information in a data entity known as a tuple, which in its broadest sense, is a data object containing one or more tuple elements into which information is organized and stored. The information stored in a tuple represents a principal, which can represent a user, a group, an application, an entity, or a device, that owns the tuple. Each tuple can be identified by a tuple identifier (ID), e.g., a uniform resource identifier (URI) or uniform resource locator (URL), and the principal can publish information to its associated tuple using the tuple ID.

An entity interested in receiving information published by a principal can subscribe to the principal's associated tuple by providing the tuple ID. When the principal publishes updated information identifying the tuple to be created or updated, the pub/sub service updates the tuple information and transmits the updated information to all interested entities, i.e., subscribers, via notification messages. The published information can be read simultaneously by any number of subscribers. So long as the subscriber remains subscribed to the tuple, the subscriber can continue to receive notification messages corresponding to the tuple principal's postings. Some pub/sub services can support filters that restrict the set of subscribers to whom updated information is transmitted. Subscribers can be principals.

Notably, as is used herein, the term “publish/subscribe” or “pub/sub” refers to the class of services and associated protocols where a subscribing client knows the tuple identifier, and thus the principal, of the tuple for which a subscription is to be established. Similarly, the publishing client knows the tuple identifier of the tuple to which it is publishing information, and can specify to which watching principals the tuple information should be sent, e.g., in a directed Publish or Notify. The subscriber receives only the most recently published information in a notification message resulting from a subscription. That is, the pub/sub service transmits to the subscriber only the most current state of the published information in response to new and/or updated tuple information.

In contrast to other services, the pub/sub services as described herein are not topic, class, or content based subscription services, which are typically included in message-oriented middleware (MOM) subscription services. Topic, class, and content based subscription systems are referred to in this document as MOM subscription services. In MOM subscription services, sometimes also referred to as pub/sub services, publishers do not publish to identified tuples, nor do subscribers subscribe to tuples of identified principals. Publishers and subscribers can be anonymous. Depending on the variant of this type of service, publishers publish information to nowhere in particular allowing the service to examine the content of the information, and distribute it to subscribers based on content filters included in their subscriptions to an identified topic, an identified class, and/or an identified type. More particularly, MOM subscription services do not send their messages to specific receivers, but instead characterize messages by topic, class, or content without knowledge of what (if any) subscribers there may be. Subscribers express interest in a topic, class, or content, and only receive messages that are of interest, without knowledge of what (if any) publishers there are. While sometimes referred to as pub/sub services, such MOM subscription services do not fall within the scope of the pub/sub services described herein.

In addition to the drawbacks of conventional mashups discussed above, there is currently no conventional provisions for creating a mashup from pub/sub content stored in pub/sub tuples and other content readily accessible via any protocol, such as a request/response protocol and for storing the mashup using a pub/sub tuple. Accordingly, there exists a need for methods, systems, and computer program products for providing a mashup using a pub/sub tuple.

### SUMMARY

Methods and systems are described for providing a mashup using a pub/sub tuple. In one aspect, mashup information identifying a content provider and having subscription information for creating a subscription to an existing pub/sub tuple is received. A mashup pub/sub tuple is created including a first element including information for obtaining first content from the existing pub/sub tuple based on the subscription information and a second element including information for obtaining second content from the identified content provider. A pub/sub principal is subscribed to the mashup pub/sub tuple. The first content and the second content are provided to the pub/sub principal pursuant to the subscription to the mashup pub/sub tuple.

In another aspect, mashup information identifying a content provider and having subscription information for creating a subscription to an existing pub/sub tuple is received. A pub/sub message is generated configured to provide a mashup pub/sub tuple including a first element including information for obtaining first content from the existing pub/sub tuple based on the subscription information and a second element including information for obtaining second content from the identified content provider. The generated pub/sub message is provided to a pub/sub service for providing the first content and second content to a pub/sub principal pursuant to a subscription to the mashup pub/sub tuple

In another aspect, a system for providing a mashup using a pub/sub tuple includes means for receiving mashup information identifying a content provider and having subscription information for creating a subscription to an existing pub/sub tuple; means for creating a mashup pub/sub tuple including a first element including information for obtaining first content from the existing pub/sub tuple based on the subscription information and a second element including information for obtaining second content from the identified content provider; means for subscribing a pub/sub principal to the mashup pub/sub tuple; and means for providing the first content and the second content to the pub/sub principal pursuant to the subscription to the mashup pub/sub tuple. At least one of the means includes at least one electronic hardware component.

In another aspect, a system for providing a mashup using a pub/sub tuple includes a message router component configured for receiving mashup information identifying a content provider and having subscription information for creating a subscription to an existing pub/sub tuple; a mashup handler component configured for creating a mashup pub/sub tuple including a first element including information for obtaining first content from the existing pub/sub tuple based on the subscription information and a second element including information for obtaining second content from the identified content provider; a subscription handler component configured for subscribing a pub/sub principal to the mashup pub/sub tuple; and a notification handler component configured for providing the first content and the second content to the pub/sub principal pursuant to the subscription to the mashup pub/sub tuple. At least one of the system components includes at least one electronic hardware component.

In another aspect, a system for providing a mashup using a pub/sub tuple includes means for receiving mashup information identifying a content provider and having subscription information for creating a subscription to an existing pub/sub tuple; means for generating a pub/sub message configured to provide a mashup pub/sub tuple including a first element including information for obtaining first content from the existing pub/sub tuple based on the subscription information and a second element including information for obtaining second content from the identified content provider; and means for providing the generated pub/sub message to a pub/sub service for providing the first content and second content to a pub/sub principal pursuant to a subscription to the mashup pub/sub tuple. At least one of the means includes at least one electronic hardware component.

In another aspect, a system for providing a mashup using a pub/sub tuple includes a mashup service component configured for receiving mashup information identifying a content provider and having subscription information for creating a subscription to an existing pub/sub tuple; a user agent component configured for generating a pub/sub message configured to provide a mashup pub/sub tuple including a first element including information for obtaining first content from the existing pub/sub tuple based on the subscription information and a second element including information for obtaining second content from the identified content provider; and a protocol agent component configured for providing the generated pub/sub message to a pub/sub service for providing the first content and second content to a pub/sub principal pursuant to a subscription to the mashup pub/sub tuple. At least one of the system components includes at least one electronic hardware component.

In another aspect, a computer readable medium storing a computer program, executable by a machine, for providing a mashup using a pub/sub tuple, is disclosed. The computer program includes executable instructions for receiving mashup information identifying a content provider and having subscription information for creating a subscription to an existing pub/sub tuple; creating a mashup pub/sub tuple including a first element including information for obtaining first content from the existing pub/sub tuple based on the subscription information and a second element including information for obtaining second content from the identified content provider; subscribing a pub/sub principal to the mashup pub/sub tuple; and providing the first content and the second content to the pub/sub principal pursuant to the subscription to the mashup pub/sub tuple.

In another aspect, a computer readable medium storing a computer program, executable by a machine, for providing a mashup using a pub/sub tuple is disclosed. The computer program includes executable instructions for receiving mashup information identifying a content provider and having subscription information for creating a subscription to an existing pub/sub tuple; generating a pub/sub message configured to provide a mashup pub/sub tuple including a first element including information for obtaining first content from the existing pub/sub tuple based on the subscription information and a second element including information for obtaining second content from the identified content provider; and providing the generated pub/sub message to a pub/sub service for providing the first content and second content to a pub/sub principal pursuant to a subscription to the mashup pub/sub tuple.

### BRIEF DESCRIPTION OF THE DRAWINGS

Advantages of the claimed invention will become apparent to those skilled in the art upon reading this description in conjunction with the accompanying drawings, in which like reference numerals have been used to designate like or analogous elements, and in which:

FIG. 1 is a block diagram illustrating an exemplary hardware device in which the subject matter may be implemented;

FIG. 2 is a flow diagram illustrating a method for providing a mashup using a pub/sub tuple according to an aspect of the subject matter described herein;

FIG. 3 is a block diagram illustrating an arrangement of components for providing a mashup using a pub/sub tuple according to another aspect of the subject matter described herein;

FIG. 4 is a block diagram illustrating an arrangement of components providing an execution environment configured to host the arrangement of components of FIG. 3;

FIG. 5 is a block diagram illustrating communications between network nodes according to another aspect of the subject matter described herein;

FIG. 6 is a block diagram illustrating communications between network nodes according to another embodiment of the subject matter described herein;

FIG. 7 is a flow diagram illustrating a method for providing a mashup using a pub/sub tuple according to another aspect of the subject matter described herein;

FIG. 8 is a block diagram illustrating an arrangement of components for providing a mashup using a pub/sub tuple according to another aspect of the subject matter described herein; and

FIG. 9 is a block diagram illustrating an arrangement of components providing an execution environment configured to host the arrangement of components of FIG. 8.

### DETAILED DESCRIPTION

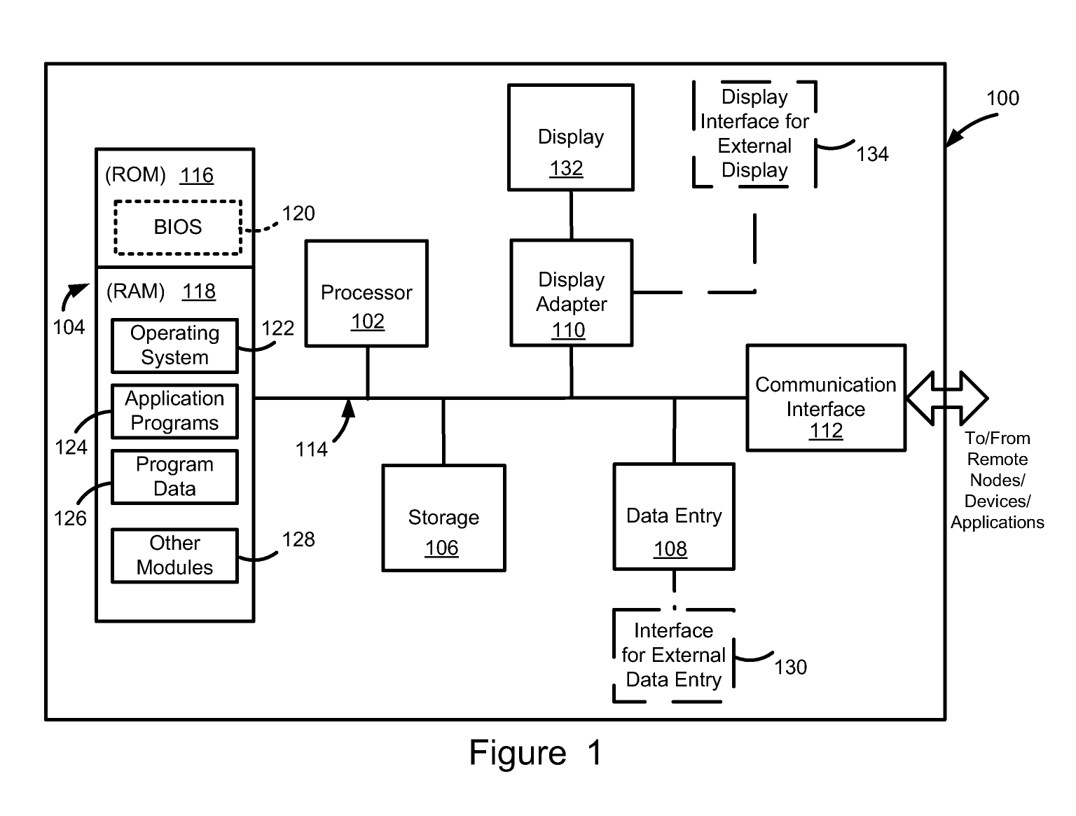

Prior to describing the subject matter in detail, an exemplary hardware device in which the subject matter may be implemented shall first be described. Those of ordinary skill in the art will appreciate that the elements illustrated in FIG. 1 may vary depending on the system implementation. With reference to FIG. 1, an exemplary system for implementing the subject matter disclosed herein includes a hardware device 100, including a processing unit 102, memory 104, storage 106, data entry module 108, display adapter 110, communication interface 112, and a bus 114 that couples elements 104-112 to the processing unit 102.

The bus 114 may comprise any type of bus architecture. Examples include a memory bus, a peripheral bus, a local bus, etc. The processing unit 102 is an instruction execution machine, apparatus, or device and may comprise a microprocessor, a digital signal processor, a graphics processing unit, an application specific integrated circuit (ASIC), a field programmable gate array (FPGA), etc. The processing unit 102 may be configured to execute program instructions stored in memory 104 and/or storage 106 and/or received via data entry module 108.

The memory 104 may include read only memory (ROM) 116 and random access memory (RAM) 118. Memory 104 may be configured to store program instructions and data during operation of device 100. In various embodiments, memory 104 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Memory 104 may also include nonvolatile memory technologies such as nonvolatile flash RAM (NVRAM) or ROM. In some embodiments, it is contemplated that memory 104 may include a combination of technologies such as the foregoing, as well as other technologies not specifically mentioned. When the subject matter is implemented in a computer system, a basic input/output system (BIOS) 120, containing the basic routines that help to transfer information between elements within the computer system, such as during start-up, is stored in ROM 116.

The storage 106 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 100. It is noted that the methods described herein can be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage 106, ROM 116 or RAM 118, including an operating system 122, one or more applications programs 124, program data 126, and other program modules 128. A user may enter commands and information into the hardware device 100 through data entry module 108. Data entry module 108 may include mechanisms such as a keyboard, a touch screen, a pointing device, etc. Other external input devices (not shown) are connected to the hardware device 100 via external data entry interface 130. By way of example and not limitation, external input devices may include a microphone, joystick, game pad, satellite dish, scanner, or the like. In some embodiments, external input devices may include video or audio input devices such as a video camera, a still camera, etc. Data entry module 108 may be configured to receive input from one or more users of device 100 and to deliver such input to processing unit 102 and/or memory 104 via bus 114.

A display 132 is also connected to the bus 114 via display adapter 110. Display 132 may be configured to display output of device 100 to one or more users. In some embodiments, a given device such as a touch screen, for example, may function as both data entry module 108 and display 132. External display devices may also be connected to the bus 114 via external display interface 134. Other peripheral output devices, not shown, such as speakers and printers, may be connected to the hardware device 100.

The hardware device 100 may operate in a networked environment using logical connections to one or more remote nodes (not shown) via communication interface 112. The remote node may be another computer, a server, a router, a peer device or other common network node, and typically includes many or all of the elements described above relative to the hardware device 100. The communication interface 112 may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, communication interface 112 may include logic configured to support direct memory access (DMA) transfers between memory 104 and other devices.

In a networked environment, program modules depicted relative to the hardware device 100, or portions thereof, may be stored in a remote storage device, such as, for example, on a server. It will be appreciated that other hardware and/or software to establish a communications link between the hardware device 100 and other devices may be used.

It should be understood that the arrangement of hardware device 100 illustrated in FIG. 1 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) can be realized, in whole or in part, by at least some of the components illustrated in the arrangement of hardware device 100. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 1. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description that follows, the subject matter will be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described below, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

The architecture, models, and protocols associated with presence services in general are described in “Request for Comments” (or RFC) documents RFC 2778 to Day et al., titled “A Model for Presence and Instant Messaging” (February 2000), RFC 2779 to Day et al., titled “Instant Messaging/Presence Protocol” (February 2000), and RFC 3921 to Saint-Andre et. al, titled “Extensible Messaging and Presence Protocol (XMPP): Instant Messaging and Presence,” each of which are published and owned by the Internet Society and are hereby incorporated by reference in their entirety. A pub/sub protocol, as defined herein, includes any protocol meeting the requirements for a presence protocol as specified in RFC 2779 with the exception that there are no requirements for the content of a pub/sub tuple. That is, a pub/sub tuple is not required to support any particular content, such as status and contact means, as required by RFC 2779 for a presence protocol. Publish and notify messages identify the updated tuple and thus identify the publishing principal. Subscribe messages identify the subscriber.

Generally speaking, one or more service nodes are used to provide pub/sub services. The function of a service node, however, can be incorporated, either in whole or in part, into other entities. For example, the presence service model can be used. The presence service model described in RFC 2778 describes two distinct agents of a presence service client. The first of these agents, called a “presentity” (combining the terms “presence” and “entity”), provides presence information to be stored and distributed throughout the presence service on behalf of a presence client. The second type of presence agent is referred to as a “watcher.” Watchers receive presence information from a presence service on behalf of a presence client.

Users of the presence service are referred to, in the presence model described in RFC 2778, as principals. Typically, a principal is a person or group that exists outside of the presence model. A principal can also be a software component, a hardware component, or other resource capable of being represented by the presence service. A principal can interact with or otherwise be represented by the presence system through a “presence user agent” (PUA) or a “watcher user agent” (WUA). As in the case of the presentity and watcher clients with which these service clients interact, the presence and watcher user agent can be combined functionally as a single user agent having both the characteristics of the presence and watcher user agents. User agents can be implemented such that their functionality exists within a presence service, external to a presence service, or a combination of both. Similar statements can be made about presentities and watchers.

As mentioned above, a pub/sub service typically stores and organizes published information into tuples. A tuple can represent any element used to store the published information associated with a resource, e.g., a publisher/principal. The published information may include general contact information for the network resource, such as a name, a telephone number, an email address, a postal address, and IP addresses or URIs associated with the resource, and the like, as well as other data or content. As used here, the tuple can also be a representation that maps field names to certain values to indicate that an entity or object (e.g., the principal) includes certain components, information, and/or perhaps has certain properties

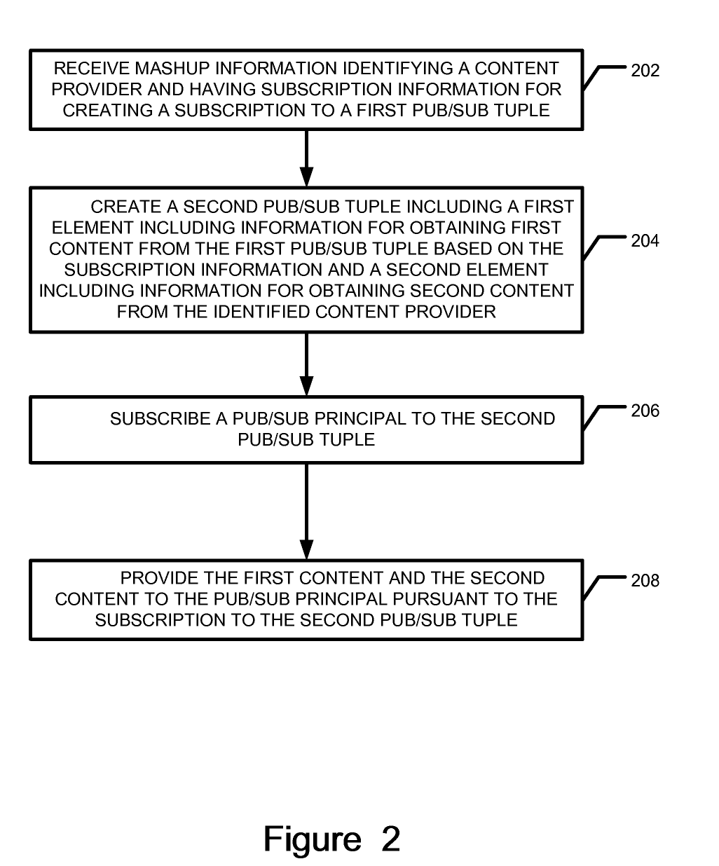

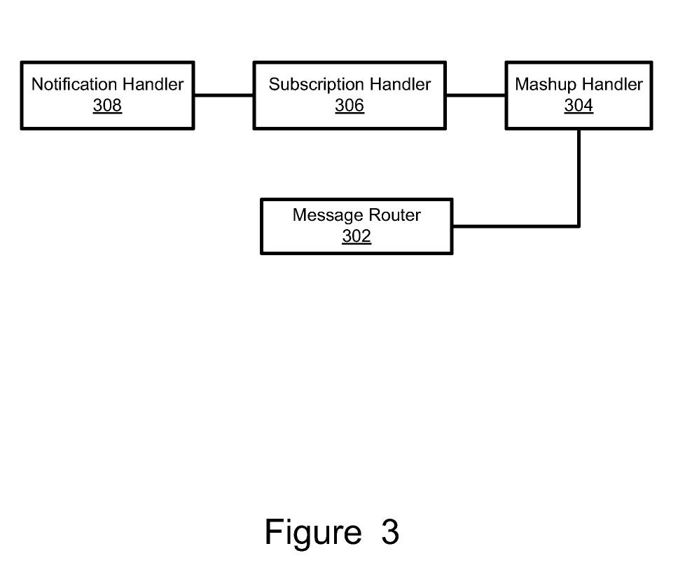

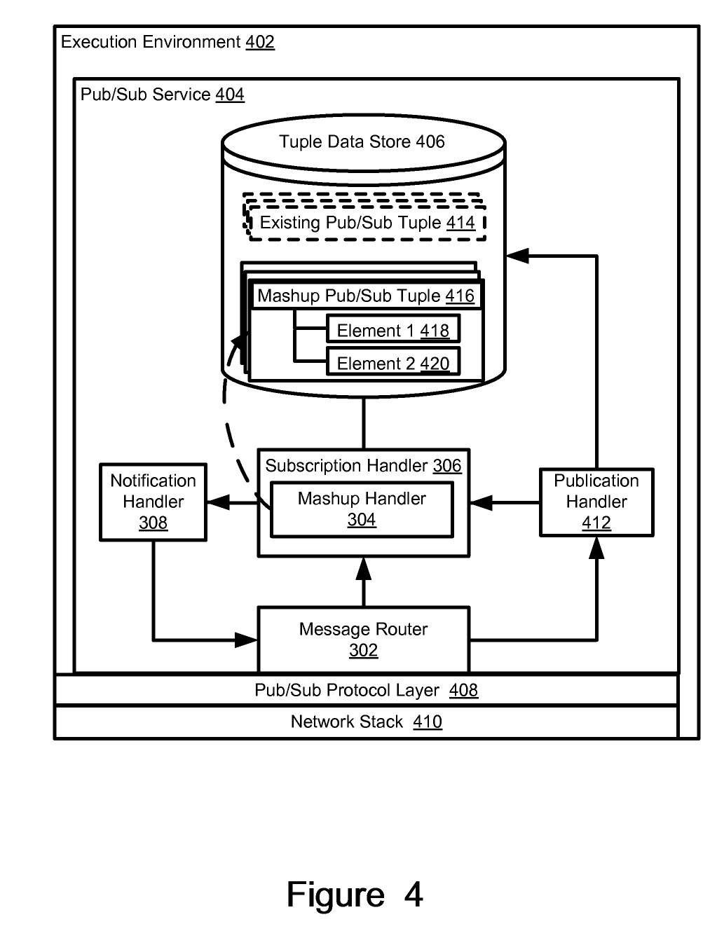

Turning now to FIG. 2, a flow diagram is illustrated illustrating a method for providing a mashup using a pub/sub tuple according to an exemplary aspect of the subject matter described herein. FIG. 3 is a block diagram illustrating an arrangement of components for providing a mashup using a pub/sub tuple according to another exemplary aspect of the subject matter described herein. FIG. 4 is a block diagram illustrating an arrangement of components providing an execution environment configured for hosting the arrangement of components depicted in FIG. 3. The method in FIG. 2 can be carried out by, for example, some or all of the components illustrated in the exemplary arrangement in FIG. 3 operating in an a compatible execution environment, such as the environment provided by some or all of the components of the arrangement in FIG. 4. The arrangement of components in FIG. 3 and/or FIG. 4 may be implemented by some or all of the components of the hardware device 100 of FIG. 1.

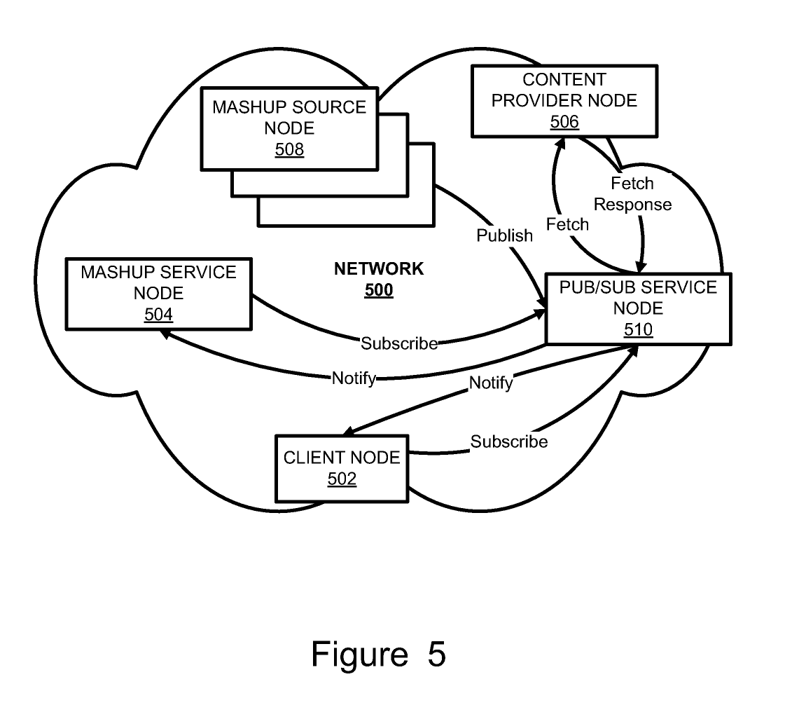

More particularly, FIG. 4 illustrates a pub/sub service 404 including the components illustrated in FIG. 3 adapted for operating in an execution environment 402. The execution environment 402, or an analog, can be provided by a node such as the pub/sub service node 510 illustrated in the block diagram of FIG. 5, which illustrates communications between network nodes. The pub/sub service 404 can include a tuple data store 406 for storing tuples 414, 416. In one embodiment, the tuples 414, 416 can be presence tuples that include a status element corresponding to a principal's status, and the pub/sub service 404 can be a presence service. The pub/sub service 404 can be configured to receive and send information from and to network nodes 502-508 via the network 500 using a pub/sub communications protocol, such as a presence protocol. The network 500 may be a Local Area Network (LAN) and/or a Wide Area Network (WAN) including the Internet.

With reference to FIG. 2, in block 202 mashup information identifying a content provider 506 and having subscription information for creating a subscription to an existing pub/sub tuple 414 is received. Accordingly, a system for providing a mashup using a pub/sub tuple includes means for receiving mashup information identifying a content provider 506 and having subscription information for creating a subscription to an existing pub/sub tuple 414. For example, as illustrated in FIG. 3 and FIG. 4, a message router component 302 is configured to receive mashup information identifying a content provider 506 and having subscription information for creating a subscription to an existing pub/sub tuple 414.

In an aspect, the message router component 302 can be adapted for operation in the pub/sub service 404 operating in an execution environment 402 illustrated in FIG. 4. Execution environment 402 can include some or all of the components illustrated in FIG. 1 configured for supporting the pub/sub service 404. The message router component 302 can be configured to receive the mashup information identifying a content provider 506 and having subscription information for creating a subscription to an existing pub/sub tuple 414 from a network node 502-508 via the network 500. The network 500 can support any protocol compatible with a configuration of the pub/sub service 404 and/or other components hosted by a node including a pub/sub service 404. For example, a suitable protocol can provide for sending the mashup information in a request in a request/response communication, in any messaging pattern supported by a pub/sub protocol, and/or in an asynchronous, unsolicited message.

According to another aspect, the message can be transmitted over the network 500 and received by a network stack 410 in the execution environment 402. At least a portion of the message can be formatted according to a pub/sub protocol, such as a presence protocol. The network stack 410 can be configured to provide at least the pub/sub formatted portion of the message to a pub/sub protocol layer 408, which in turn can pass the message to the message router component 302.

In an aspect, receiving mashup information includes receiving one or more messages according to a pub/sub protocol. For example, the message router component 302 can be configured to receive mashup information by receiving one or more messages according to a pub/sub protocol. The message router component 302 can be configured to route the received message based on, for example, a message type detected in, and/or a schema supported by, the received information. For example, when the mashup information is included in a pub/sub SUBSCRIBE message the message router 408 can be configured to route the message to a subscription handler component 306. For example, as illustrated in FIG. 5, a SUBSCRIBE message can be received from a mashup service node 504 and/or a client node 502. Alternatively, when the mashup information is included in a pub/sub PUBLISH message the message router 302 can be configured to route the message to a publication handler component 412. For example, as illustrated in FIG. 5, a PUBLISH message can be received from a mashup source node 508. Alternatively, when the mashup information is included in a pub/sub NOTIFY command, including a directed NOTIFY message, the message router 302 can be configured to route the message to a notification handler component 308.

It should however be appreciated that the mashup information can be received via any suitable protocol that can provide for sending the mashup information, such as via a request in a request/response communication, in any messaging pattern supported by a pub/sub protocol, and/or in an asynchronous, unsolicited message.

In another aspect, the mashup information includes a URI identifying content provided by a content provider, such as content provider node 506 in FIG. 5. For example, the message router component 302 can be configured to receive mashup information identifying a content provider by receiving a URI identifying content provided by a content provider. The URI can be, for example, a URL identifying content stored on a server or can identify a server or group of servers and provide an identifier for locating the content on the server or group of servers identified by the URL.

In another aspect, the received mashup information identifies a pub/sub client, an HTTP server, a remote procedure call (RPC) server, and a really simple syndication (RSS) service.

In another aspect, the mashup information is received in one or more messages from at least one of a pub/sub principal represented by the existing pub/sub tuple 414 and the identified content provider. For example, the message router component 302 can be configured to receive mashup information by receiving one or more messages from client node 502 for a pub/sub principal represented by the existing pub/sub tuple 414 or, as stated above, can be received from the content provider node 506, which can be the content provider identified in the mashup information. Alternatively, the mashup information can be received from the content provider node 506 and identify another content provider.

The received mashup information also includes subscription information for creating a subscription to an existing pub/sub tuple 414. For example, a pub/sub tuple stored in a tuple data store 406 can represent a principal associated with the client node 502, or another node, and the received mashup information can include an identifier for the stored pub/sub tuple. The subscription information including the tuple ID is provided to the subscription handler component 306 for establishing a subscription to the existing pub/sub tuple 414 stored in the tuple data store 406.

Returning to FIG. 2, in block 204 a mashup pub/sub tuple 416 is created including a first element 418 including information for obtaining first content from the existing pub/sub tuple 414 based on the subscription information and a second element 420 including information for obtaining second content from the identified content provider 506. Accordingly, a system for providing a mashup using a pub/sub tuple includes means for creating a mashup pub/sub tuple 416 including a first element 418 including information for obtaining first content from the existing pub/sub tuple 414 based on the subscription information and a second element 420 including information for obtaining second content from the identified content provider 506. For example, as illustrated in FIG. 3 and FIG. 4, a mashup handler component 304 is configured to create a mashup pub/sub tuple 416 including a first element 418 including information for obtaining first content from the existing pub/sub tuple 414 based on the subscription information and a second element 420 including information for obtaining second content from the identified content provider 506. Although the existing pub/sub tuple 414 and the mashup pub/sub tuple 416 are shown for illustrative purposes in the same tuple data store 406 handled by the same pub/sub service 404, it should be understood that the existing pub/sub tuple 414 and the mashup pub/sub tuple 416 can be stored in different tuple data stores and/or handled by different pub/sub services 404 and even different pub/sub service nodes 510.

With reference to FIG. 5, a mashup service node 504 can send a pub/sub SUBSCRIBE message to the pub/sub service node 510. Mashup service node 504 can be, for example, a pub/sub watching client. The mashup information is received in the SUBSCRIBE message, as described above, and is forwarded via the message router component 302 to the mashup handler component 304 in the pub/sub service 404 of the pub/sub service node 510. In FIG. 4, the mashup handler component 304 is shown operating in conjunction with the subscription handler component 306 by way of example. It should be understood that the mashup handler component 304 can be included in and/or operate in conjunction with any one or more of the subscription handler component 306, the notification handler component 308, and the publication handler component 212. Accordingly, as described above, the mashup information can be received in a SUBSCRIBE message, a PUBLISH message, and/or a NOTIFY message to be handled by the mashup handler component 304 in conjunction with, respectively, the subscription handler component 306, the publication handler component 412, and/or the notification handler component 308.

The mashup handler component 304, in any event, processes the mashup information and creates the mashup pub/sub tuple 416 in the tuple data store 406. In the current example, the SUBSCRIBE message from the mashup service node 504 includes the mashup information and is processed by the mashup handler component 304 to create the mashup pub/sub tuple 416 including a first element 418 including information for obtaining first content from the existing pub/sub tuple 414 based on the subscription information and a second element 420 including information for obtaining second content from the identified content provider 506.

In an aspect, a subscription to the existing pub/sub tuple 414 for the mashup pub/sub tuple 416 based on the subscription information and obtaining the first content from the existing pub/sub tuple 414 pursuant to the subscription to the existing pub/sub tuple 414. For example, the mashup handler component 304 can be configured to create a mashup pub/sub tuple 416 by invoking the subscription handler component 306 for establishing a subscription to the existing pub/sub tuple 414 for the mashup pub/sub tuple 416 based on the subscription information and obtaining the first content from the existing pub/sub tuple 414 pursuant to the subscription to the existing pub/sub tuple 414.

In another aspect, creating the mashup pub/sub tuple 416 includes providing for obtaining the second content from the content provider 506 according to a synchronous protocol. For example, the mashup handler component 304 can be configured to create a mashup pub/sub tuple 416 by invoking the message router component 302 and the network stack 410 to provide a request/response protocol, such as HTTP, to fetch the second content from the content provider 506, as illustrated in FIG. 5 by the fetch and fetch response messages.

In another aspect, the mashup handler component 304 is configured to create a mashup pub/sub tuple 416 by providing for polling the content provider 506 to obtain the second content. The mashup handler component 304 and/or subscription handler component 306 can communicate with the content provider node 506 to get updated content using HTTP, RSS, or any suitable protocol.

In another aspect, the mashup handler component 304 is configured to create a mashup pub/sub tuple 416 by creating or updating a first one of the first and second elements 418, 420 and creating or updating a second one of the first and second elements 418, 420 based on information obtained from the creating or updating of the first one of the first and second elements 420. For example, the first content of the first element 418 can include retrieval information (e.g., URI) for the second content and/or other information, such as state information, that is processed and used for determining a location of the second content and/or whether or not to retrieve or update the second content. Alternatively, the second content of the second element 420 can include retrieval information (e.g., tuple ID) for the first content and/or other information, such as state information, that is processed and used for determining a location of the first content and/or whether or not to retrieve or update the first content.

In another aspect, at least one of the first content and the second content is metadata of a resource for locating the resource. For example, the first content and/or the second content can include metadata in the form of retrieval information (e.g., tuple ID, URI) for retrieving additional content, such as a network-accessible resource.

Returning to FIG. 2, in block 206 a pub/sub principal is subscribed to the mashup pub/sub tuple 416. Accordingly, a system for providing a mashup using a pub/sub tuple includes means for subscribing a pub/sub principal to the mashup pub/sub tuple 416. For example, as illustrated in FIG. 3 and FIG. 4, a subscription handler component 306 is configured to subscribe a pub/sub principal to the mashup pub/sub tuple 416.

The subscription handler component 306 can be invoked by the mashup handler component 304 to establish a subscription to the newly created mashup pub/sub tuple 416. Alternatively, the subscription handler component 306 can be configured to receive a SUBSCRIBE message from another network node to establish a subscription to the newly created mashup pub/sub tuple. In one aspect, the pub/sub principal subscribed to the mashup pub/sub tuple 416 can be associated with the mashup service node 504 that sent the original SUBSCRIBE message to the pub/sub service node 510. Alternatively, the pub/sub principal can be associated with a client node 502.

In another aspect, a pub/sub principal represented by the existing pub/sub tuple 414 is subscribed to the mashup pub/sub tuple 416. For example, the subscription handler component 306 can be configured to subscribe a pub/sub principal represented by the existing pub/sub tuple 414 to the mashup pub/sub tuple 416, such as a pub/sub principal associated with the mashup service node 504 or client node 502.

In another aspect, the subscription handler 306 can be configured to determine whether to subscribe the pub/sub principal to the mashup pub/sub tuple 416 based on information obtained from creating or updating the first and second elements 418, 420. For example, the subscription handler component 306 can be configured to update the first element 418 and based on information in the update, or read in connection with the update, determine whether the pub/sub principal should be subscribed. In one example, if the content of the first element 418 of the mashup pub/sub tuple 416 is determined to not be of interest to the pub/sub principal, the subscription is not carried out.

Returning to FIG. 2, in block 208 the first content and the second content is provided to the pub/sub principal pursuant to the subscription to the mashup pub/sub tuple 416. Accordingly, a system for providing a mashup using a pub/sub tuple includes means for providing the first content and the second content to the pub/sub principal pursuant to the subscription to the mashup pub/sub tuple 416. For example, as illustrated in FIG. 3, a notification handler component 308 is configured to provide the first content and the second content to the pub/sub principal pursuant to the subscription to the mashup pub/sub tuple 416.

Once a pub/sub principal is subscribed to the mashup pub/sub tuple 416, the first content and the second content is provided to the pub/sub principal pursuant to the subscription. Changes and updates to the mashup pub/sub tuple 416 can be made via a pub/sub PUBLISH message. In one aspect, a mashup source node 508 publishes updates to the mashup pub/sub tuple as shown in FIG. 5. The pub/sub principal receives a message pursuant to the subscription to the mashup pub/sub tuple 416. Changes are detected by the notification handler component 308 and an appropriate message is generated and sent via the message router component 302 to the pub/sub principal. In one aspect, the notification handler component 308 is configured to provide the first content and the second content to the pub/sub principal by sending a pub/sub NOTIFY message to the pub/sub principal.

In another aspect, the first content and the second content is provided to the pub/sub principal translated into a format suitable for presentation by a client of the pub/sub principal. For example, the notification handler component 308 can be configured to provide the first content and the second content to the pub/sub principal by translating the contents into a format suitable for presentation by the client node 502 of the pub/sub principal.

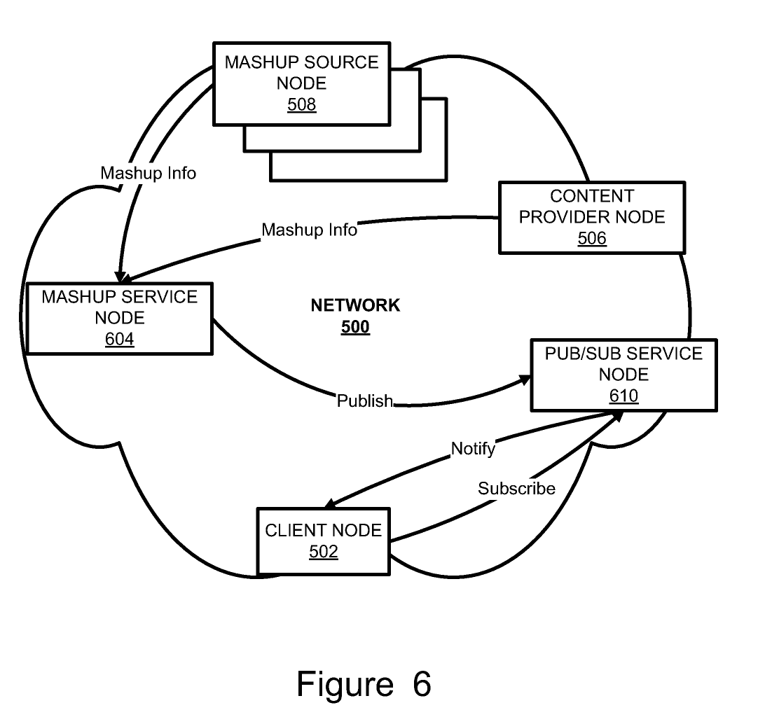

In an alternative embodiment illustrated in FIGS. 6-9, a mashup service node 604 gathers the mashup information and invokes a pub/sub service node 610 to create a mashup pub/sub tuple 416. Pub/sub service node 610 is as illustrated in FIG. 4 but does not require a mashup handler 304. More particularly, pub/sub service node 610 can be configured as a conventional pub/sub service, since the mashup information is processed by the mashup service node 604, which sends a pub/sub PUBLISH message to create the mashup pub/sub tuple 416 as the pub/sub service node 610. The mashup service node 604 can itself be a pub/sub service with an agent for creating mashup tuples on other pub/sub services.

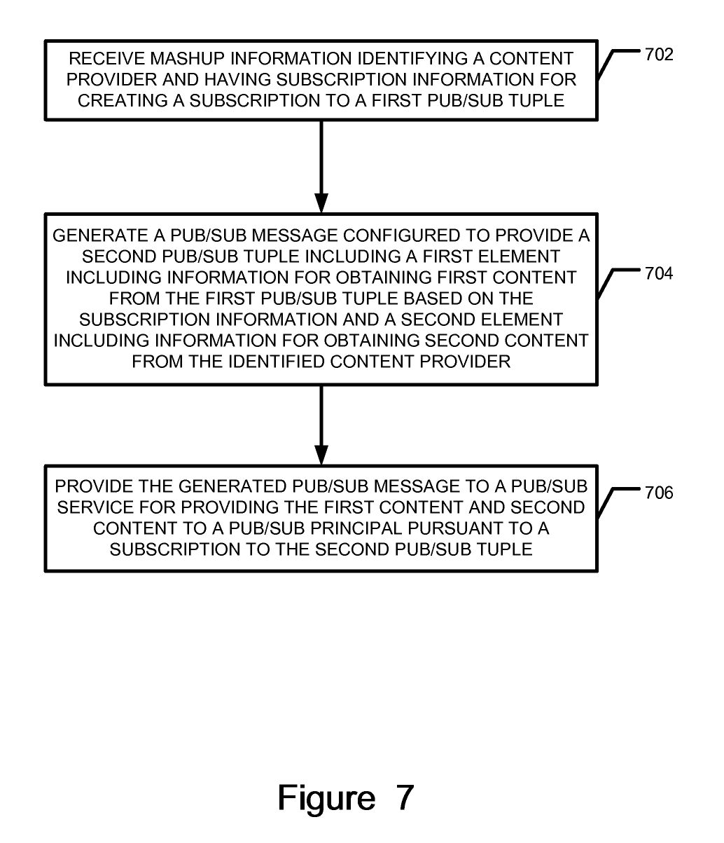

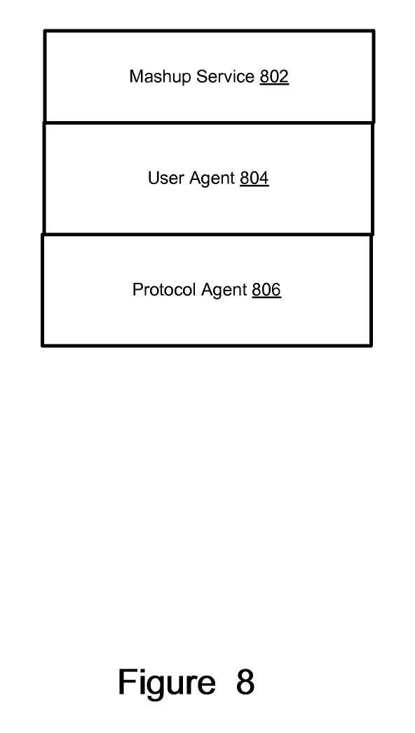

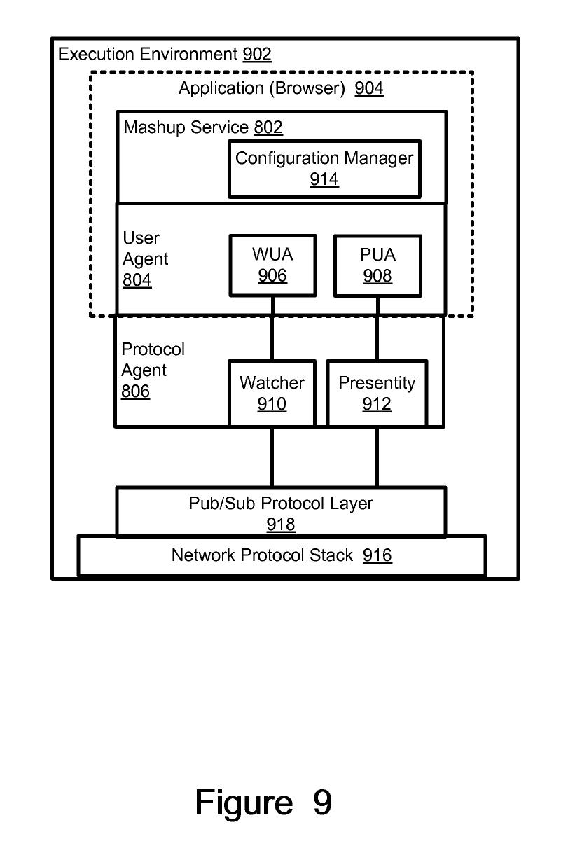

Turning now to FIG. 7, a flow diagram is illustrated illustrating a method for providing a mashup using a pub/sub tuple according to the exemplary embodiment described in connection with FIGS. 6-9 of the subject matter described herein. FIG. 8 is a block diagram illustrating a system for providing a mashup using a pub/sub tuple according to another exemplary aspect of the subject matter described herein. FIG. 9 is a block diagram illustrating an arrangement of components providing an execution environment configured for hosting the arrangement of components depicted in FIG. 8. The method in FIG. 7 can be carried out by, for example, some or all of the components illustrated in the exemplary arrangement in FIG. 8 operating in an a compatible execution environment, such as the environment provided by some or all of the components of the arrangement in FIG. 9. The arrangement of components in FIG. 9 may be implemented by some or all of the components of the hardware device 100 of FIG. 1.

With reference to FIG. 7, in block 702 mashup information identifying a content provider 506 and having subscription information for creating a subscription to an existing pub/sub tuple 414 is received at mashup service node 604. Accordingly, a system for providing a mashup using a pub/sub tuple includes means for receiving mashup information identifying a content provider 506 and having subscription information for creating a subscription to an existing pub/sub tuple 414. For example, as illustrated in FIG. 8 and FIG. 9, a mashup service component 802 is configured to receive mashup information identifying a content provider 506 and having subscription information for creating a subscription to an existing pub/sub tuple 414.

FIG. 9 shows the components of FIG. 8 operating in an execution environment 902 or a pub/sub client. The execution environment 902 can be hosted by the mashup service node 604 illustrated in FIG. 6. The mashup service node 604 may alternatively support the components of FIG. 8 directly without the execution environment 902 of a pub/sub client. As illustrated in FIG. 9, the mashup service component 802 and a user agent component 804 can operate as part of another application 904, such as a desktop application or a browser.

The user agent component 804 illustrated in FIG. 9 includes a WUA 906 and/or PUA 908, discussed above, for providing a SUBSCRIBE and/or a PUBLISH message, respectively, to create the mashup pub/sub tuple. Similarly, a protocol agent component 806 can include a corresponding watcher 910 and/or a presentity 912, respectively, for providing a SUBSCRIBE and/or a PUBLISH message. Alternatively, the user agent component 804 and protocol agent component 806 can be adapted to work with another suitable protocol. In the example of FIG. 9 where the system operates in an execution environment 902 of a pub/sub client, the mashup service component 802 can include a configuration manager 914 that includes one or more services configured to receive and process input, such as GUI manager including one or more widget handlers, a storage manager, and/or a communications manager.

As illustrated in FIG. 6, mashup information is received at the mashup service node 604 from the mashup source node 508 and/or the content provider node 506. For example, a message received from the mashup source node 508 can include mashup information including subscription information for creating a subscription to an existing pub/sub tuple 414. Similarly, a message can be received from the content provider node 506 that includes mashup information identifying a content provider, where the message can identify content provider 506 and/or another content provider. Alternatively, a single message, or multiple messages, containing mashup information can be received from any of the mashup source node 408, the content provider node 506, or another network node. With reference to FIG. 9, the one or more messages including the mashup information can be received by the mashup service component 802 over network 500 via a network protocol stack 916.

In one aspect, mashup information is received in one or more messages according to a pub/sub protocol. For example, the mashup service component 802 is configured to receive mashup information by receiving one or more messages according to a pub/sub protocol. In such a case, with reference again to FIG. 9, a pub/sub protocol layer 918 is invoked by the network protocol stack 916 to provide the pub/sub messages to the mashup service component 802. Alternatively, the mashup information can be received according to a request/response protocol, or any other suitable protocol via the network protocol stack 916.

In an aspect, the received mashup information includes a URI identifying content. For example, the mashup service component 802 can be configured to receive mashup information with a URI identifying content provided by the content provider 506. In another aspect, mashup information received identifies a pub/sub client, an HTTP server, an RPC server, and/or an RSS service. For example, the mashup service component 802 can be configured to receive mashup information identifying a content provider 506 by receiving information identifying a pub/sub client, an HTTP server, an RPC server, and an RSS service.

In another aspect, one or more messages are received from at least one of a pub/sub principal represented by the existing pub/sub tuple 414 and the identified content provider 506. For example, the mashup service component 802 can be configured to receive mashup information by receiving one or more messages from at least one of a pub/sub principal represented by the existing pub/sub tuple 414, such as principal associated with client node 502, and the identified content provider 506.

Returning to FIG. 7, in block 704 a pub/sub message is generated configured to provide a mashup pub/sub tuple 416 including a first element 418 including information for obtaining first content from the existing pub/sub tuple 414 based on the subscription information and a second element 420 including information for obtaining second content from the identified content provider 506. Accordingly, a system for providing a mashup using a pub/sub tuple includes means for generating a pub/sub message configured to provide a mashup pub/sub tuple 416 including a first element 418 including information for obtaining first content from the existing pub/sub tuple 414 based on the subscription information and a second element 420 including information for obtaining second content from the identified content provider 506. For example, as illustrated in FIG. 8 and FIG. 9, the user agent component 804 is configured to generate a pub/sub message configured to provide a mashup pub/sub tuple 416 including a first element 418 including information for obtaining first content from the existing pub/sub tuple 414 based on the subscription information and a second element 420 including information for obtaining second content from the identified content provider 506.

In one aspect, a subscription to the existing pub/sub tuple 414 is established for the mashup pub/sub tuple 416 based on the subscription information and the first content is obtained from the existing pub/sub tuple 414 pursuant to the subscription to the existing pub/sub tuple 414. For example, the user agent component 804 is configured to establish a subscription to the existing pub/sub tuple 414 for the mashup pub/sub tuple 416 based on the subscription information and obtain the first content from the existing pub/sub tuple 414 pursuant to the subscription to the existing pub/sub tuple 414.

In another aspect, the second content is obtained from the content provider 506 according to a synchronous protocol, such as HTTP. For example, the user agent component 804 can be configured to obtain the second content from the content provider 506 via the network protocol stack 916 according to a synchronous protocol. In another aspect, the user agent component 804 can be configured to poll the content provider 506 to obtain the second content.

In another aspect, the user agent component 804 is configured to generate a pub/sub publish message configured to provide a mashup pub/sub tuple 416 by creating or updating a first one of the first and second elements 418, 420 and creating or updating a second one of the first and second elements 418, 420 based on information obtained from the creating or updating of the first one of the first and second elements 420. For example, the first content of the first element 418 can include retrieval information (e.g., URI) for the second content and/or other information, such as state information, that is processed and used for determining a location of the second content and/or whether or not to retrieve or update the second content. Alternatively, the second content of the second element 420 can include retrieval information (e.g., tuple ID) for the first content and/or other information, such as state information, that is processed and used for determining a location of the first content and/or whether or not to retrieve or update the first content.

In another aspect, at least one of the first content and the second content is metadata of a resource for locating the resource. For example, the first content and/or the second content can include metadata in the form of retrieval information (e.g., tuple ID, URI) for retrieving additional content, such as a network-accessible resource.

Returning to FIG. 7, in block 706 the generated pub/sub message is provided to the pub/sub service 610 for providing the first content and second content to a pub/sub principal pursuant to a subscription to the mashup pub/sub tuple 416. Accordingly, a system for providing a mashup using a pub/sub tuple includes means for providing the generated pub/sub message to the pub/sub service 610 for providing the first content and second content to a pub/sub principal pursuant to a subscription to the mashup pub/sub tuple 416. For example, as illustrated in FIG. 8 and FIG. 9, a protocol agent component 806 is configured to provide the generated pub/sub message to the pub/sub service 610 for providing the first content and second content to a pub/sub principal pursuant to a subscription to the mashup pub/sub tuple 416.

In one aspect, a pub/sub publish message is sent to the pub/sub service 610. For example, the protocol agent component 806 can be configured to provide the generated pub/sub message to a pub/sub service by sending a pub/sub publish message to the pub/sub service 610, as illustrated in FIG. 6.

In another aspect, a pub/sub subscribe message is sent to the pub/sub service 610. For example, the protocol agent component 806 is configured to provide the generated pub/sub message to a pub/sub service by sending a pub/sub subscribe message to the pub/sub service.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for providing a mashup using a pub/sub tuple, the method comprising:
receiving mashup information identifying a content provider and having subscription information for creating a subscription to an existing pub/sub tuple;
creating a mashup pub/sub tuple including a first element including information for obtaining first content from the existing pub/sub tuple based on the subscription information and a second element including information for obtaining second content from the identified content provider;
subscribing a pub/sub principal to the mashup pub/sub tuple; and
providing the first content and the second content to the pub/sub principal pursuant to the subscription to the mashup pub/sub tuple,
wherein at least one of the preceding actions is performed on at least one electronic hardware component.

2. The method of claim 1 wherein receiving mashup information includes receiving one or more messages according to a pub/sub protocol.

3. The method of claim 1 wherein receiving mashup information identifying a content provider includes receiving a uniform resource identifier (URI) identifying content provided by a content provider.

4. The method of claim 1 wherein receiving mashup information identifying a content provider includes receiving information identifying a pub/sub client, a hypertext transfer protocol (HTTP) server, an remote procedure call (RPC) server, and a really simple syndication (RSS) service.

5. The method of claim 1 wherein receiving mashup information includes receiving one or more messages from at least one of a pub/sub principal represented by the existing pub/sub tuple and the identified content provider.

6. The method of claim 1 wherein creating a mashup pub/sub tuple includes establishing a subscription to the existing pub/sub tuple for the mashup pub/sub tuple based on the subscription information and obtaining the first content from the existing pub/sub tuple pursuant to the subscription to the existing pub/sub tuple.

7. The method of claim 1 wherein creating a mashup pub/sub tuple includes providing for obtaining the second content from the content provider according to a synchronous protocol.

8. The method of claim 1 wherein creating a mashup pub/sub tuple includes providing for polling the content provider to obtain the second content.

9. The method of claim 1 wherein creating a mashup pub/sub tuple includes:
creating or updating a first one of the first and second elements; and
creating or updating a second one of the first and second elements based on information obtained from the creating or updating of the first one of the first and second elements.

10. The method of claim 1 wherein at least one of the first content and the second content is metadata of a resource for locating the resource.

11. The method of claim 1 wherein subscribing a pub/sub principal to the mashup pub/sub tuple includes receiving a pub/sub subscribe message.

12. The method of claim 1 wherein subscribing a pub/sub principal to the mashup pub/sub tuple includes subscribing a pub/sub principal represented by the existing pub/sub tuple.

13. The method of claim 1 wherein subscribing a pub/sub principal to the mashup pub/sub tuple includes determining whether to subscribe the pub/sub principal to the mashup pub/sub tuple based on information obtained from creating or updating the first and second elements.

14. The method of claim 1 wherein providing the first content and the second content to the pub/sub principal includes sending a pub/sub notification message to the pub/sub principal.

15. The method of claim 1 wherein providing the first content and the second content to the pub/sub principal includes translating the contents into a format suitable for presentation by a client of the pub/sub principal.

16. A method for providing a mashup using a pub/sub tuple, the method comprising:
receiving mashup information identifying a content provider and having subscription information for creating a subscription to an existing pub/sub tuple;
generating a pub/sub message configured to provide a mashup pub/sub tuple including a first element including information for obtaining first content from the existing pub/sub tuple based on the subscription information and a second element including information for obtaining second content from the identified content provider; and
providing the generated pub/sub message to a pub/sub service for providing the first content and second content to a pub/sub principal pursuant to a subscription to the mashup pub/sub tuple;
wherein at least one of the preceding actions is performed on at least one electronic hardware component.

17. The method of claim 16 wherein receiving mashup information includes receiving one or more messages according to a pub/sub protocol.

18. The method of claim 16 wherein receiving mashup information identifying a content provider includes receiving a uniform resource identifier (URI) identifying content provided by a content provider.

19. The method of claim 16 wherein receiving mashup information identifying a content provider includes receiving information identifying a pub/sub client, an HTTP server, an RPC server, and an RSS service.

20. The method of claim 16 wherein receiving mashup information includes receiving one or more messages from at least one of a pub/sub principal represented by the existing pub/sub tuple and the identified content provider

21. The method of claim 16 wherein generating a pub/sub publish message configured to provide a mashup pub/sub tuple includes establishing a subscription to the existing pub/sub tuple for the mashup pub/sub tuple based on the subscription information and obtaining the first content from the existing pub/sub tuple pursuant to the subscription to the existing pub/sub tuple.

22. The method of claim 16 wherein generating a pub/sub publish message configured to provide a mashup pub/sub tuple includes providing for obtaining the second content from the content provider according to a synchronous protocol.

23. The method of claim 16 wherein generating a pub/sub publish message configured to provide a mashup pub/sub tuple includes providing for polling the content provider to obtain the second content.

24. The method of claim 16 wherein generating a pub/sub publish message configured to provide a mashup pub/sub tuple includes:
creating or updating a first one of the first and second elements; and
creating or updating a second one of the first and second elements based on information obtained from the creating or updating of the first one of the first and second elements.

25. The method of claim 16 wherein at least one of the first content and the second content is metadata of a resource for locating the resource.

26. The method of claim 16 wherein providing the generated pub/sub message to a pub/sub service includes sending a pub/sub publish message to the pub/sub service.

27. The method of claim 16 wherein providing the generated pub/sub message to a pub/sub service includes sending a pub/sub subscribe message to the pub/sub service.

28. The method of claim 16 wherein providing the generated pub/sub publish message to a pub/sub service.

29. A system for providing a mashup using a pub/sub tuple, the system comprising:
means for receiving mashup information identifying a content provider and having subscription information for creating a subscription to an existing pub/sub tuple;
means for creating a mashup pub/sub tuple including a first element including information for obtaining first content from the existing pub/sub tuple based on the subscription information and a second element including information for obtaining second content from the identified content provider;
means for subscribing a pub/sub principal to the mashup pub/sub tuple; and
means for providing the first content and the second content to the pub/sub principal pursuant to the subscription to the mashup pub/sub tuple;
wherein at least one of the means includes at least one electronic hardware component.

30. A system for providing a mashup using a pub/sub tuple, the system comprising system components including:
a message router component configured to receive mashup information identifying a content provider and having subscription information for creating a subscription to an existing pub/sub tuple;
a mashup handler component configured to create a mashup pub/sub tuple including a first element including information for obtaining first content from the existing pub/sub tuple based on the subscription information and a second element including information for obtaining second content from the identified content provider;
a subscription handler component configured to subscribe a pub/sub principal to the mashup pub/sub tuple; and
a notification handler component configured to provide the first content and the second content to the pub/sub principal pursuant to the subscription to the mashup pub/sub tuple;
wherein at least one of the system components includes at least one electronic hardware component.

31. The system of claim 30 wherein the message router component is configured to receive mashup information by receiving one or more messages according to a pub/sub protocol.

32. The system of claim 30 wherein the message router component is configured to receive mashup information identifying a content provider by receiving a uniform resource identifier (URI) identifying content provided by a content provider.

33. The system of claim 30 wherein the message router component is configured to receive mashup information identifying a content provider by receiving information identifying a pub/sub client, an HTTP server, an RPC server, and an RSS service.

34. The system of claim 30 wherein the message router component is configured to receive mashup information by receiving one or more messages from at least one of a pub/sub principal represented by the existing pub/sub tuple and the identified content provider.

35. The system of claim 30 wherein the mashup handler component is configured to create a mashup pub/sub tuple by establishing a subscription to the existing pub/sub tuple for the mashup pub/sub tuple based on the subscription information and obtaining the first content from the existing pub/sub tuple pursuant to the subscription to the existing pub/sub tuple.

36. The system of claim 30 wherein the mashup handler component is configured to create a mashup pub/sub tuple by providing for obtaining the second content from the content provider according to a synchronous protocol.

37. The system of claim 30 wherein the mashup handler component is configured to create a mashup pub/sub tuple by providing for polling the content provider to obtain the second content.

38. The system of claim 30 wherein the mashup handler component is configured to create a mashup pub/sub tuple by:
creating or updating a first one of the first and second elements; and
creating or updating a second one of the first and second elements based on information obtained from the creating or updating of the first one of the first and second elements.

39. The system of claim 30 wherein at least one of the first content and the second content is metadata of a resource for locating the resource.

40. The system of claim 30 wherein the subscription handler component is configured to subscribe a pub/sub principal to the mashup pub/sub tuple by receiving a pub/sub subscribe message.

41. The system of claim 30 wherein the subscription handler component is configured to subscribe a pub/sub principal to the mashup pub/sub tuple by subscribing a pub/sub principal represented by the existing pub/sub tuple.

42. The system of claim 30 wherein the subscription handler component is configured to subscribe a pub/sub principal to the mashup pub/sub tuple by determining whether to subscribe the pub/sub principal to the mashup pub/sub tuple based on information obtained from creating or updating the first and second elements.

43. The system of claim 30 wherein the notification handler component is configured to provide the first content and the second content to the pub/sub principal by sending a pub/sub notification message to the pub/sub principal.

44. The system of claim 30 wherein the notification handler component is configured to provide the first content and the second content to the pub/sub principal by translating the contents into a format suitable for presentation by a client of the pub/sub principal.

45. A system for providing a mashup using a pub/sub tuple, the system comprising:
means for receiving mashup information identifying a content provider and having subscription information for creating a subscription to an existing pub/sub tuple;
means for generating a pub/sub message configured to provide a mashup pub/sub tuple including a first element including information for obtaining first content from the existing pub/sub tuple based on the subscription information and a second element including information for obtaining second content from the identified content provider; and
means for providing the generated pub/sub message to a pub/sub service for providing the first content and second content to a pub/sub principal pursuant to a subscription to the mashup pub/sub tuple;
wherein at least one of the means includes at least one electronic hardware component.

46. A system for providing a mashup using a pub/sub tuple, the system comprising system components including:
a mashup service component configured to receive mashup information identifying a content provider and having subscription information for creating a subscription to an existing pub/sub tuple;
a user agent component configured to generate a pub/sub message configured to provide a mashup pub/sub tuple including a first element including information for obtaining first content from the existing pub/sub tuple based on the subscription information and a second element including information for obtaining second content from the identified content provider; and
a protocol agent component configured to provide the generated pub/sub message to a pub/sub service for providing the first content and second content to a pub/sub principal pursuant to a subscription to the mashup pub/sub tuple;
wherein at least one of the system components includes at least one electronic hardware component.

47. The system of claim 46 wherein the mashup service component is configured to receive mashup information by receiving one or more messages according to a pub/sub protocol.

48. The system of claim 46 wherein the mashup service component is configured to receive mashup information identifying a content provider by receiving a uniform resource identifier (URI) identifying content provided by a content provider.

49. The system of claim 46 wherein the mashup service component is configured to receive mashup information identifying a content provider by receiving information identifying a pub/sub client, an HTTP server, an RPC server, and an RSS service.

50. The system of claim 46 wherein the mashup service component is configured to receive mashup information by receiving one or more messages from at least one of a pub/sub principal represented by the existing pub/sub tuple and the identified content provider

51. The system of claim 46 wherein the user agent component is configured to generate a pub/sub publish message configured to provide a mashup pub/sub tuple by establishing a subscription to the existing pub/sub tuple for the mashup pub/sub tuple based on the subscription information and obtain the first content from the existing pub/sub tuple pursuant to the subscription to the existing pub/sub tuple.

52. The system of claim 46 wherein the user agent component is configured to generate a pub/sub publish message configured to provide a mashup pub/sub tuple by providing for obtaining the second content from the content provider according to a synchronous protocol.

53. The system of claim 46 wherein the user agent component is configured to generate a pub/sub publish message configured to provide a mashup pub/sub tuple by providing for polling the content provider to obtain the second content.

54. The system of claim 46 wherein the user agent component is configured to generate a pub/sub publish message configured to provide a mashup pub/sub tuple by:
creating or updating a first one of the first and second elements; and
creating or updating a second one of the first and second elements based on information obtained from the creating or updating of the first one of the first and second elements.

55. The system of claim 46 wherein at least one of the first content and the second content is metadata of a resource for locating the resource.

56. The system of claim 46 wherein the protocol agent component is configured to provide the generated pub/sub message to a pub/sub service by sending a pub/sub publish message to the pub/sub service.

57. The system of claim 46 wherein the protocol agent component is configured to provide the generated pub/sub message to a pub/sub service by sending a pub/sub subscribe message to the pub/sub service.

58. The system of claim 46 wherein the protocol agent component is configured to provide the generated pub/sub publish message to a pub/sub service.

59. A computer readable medium storing a computer program, executable by a machine, for providing a mashup using a pub/sub tuple, the computer program comprising executable instructions for:
receiving mashup information identifying a content provider and having subscription information for creating a subscription to an existing pub/sub tuple;
creating a mashup pub/sub tuple including a first element including information for obtaining first content from the existing pub/sub tuple based on the subscription information and a second element including information for obtaining second content from the identified content provider;
subscribing a pub/sub principal to the mashup pub/sub tuple; and
providing the first content and the second content to the pub/sub principal pursuant to the subscription to the mashup pub/sub tuple.

60. A computer readable medium storing a computer program, executable by a machine, for providing a mashup using a pub/sub tuple, the computer program comprising executable instructions for:
receiving mashup information identifying a content provider and having subscription information for creating a subscription to an existing pub/sub tuple;
generating a pub/sub message configured to provide a mashup pub/sub tuple including a first element including information for obtaining first content from the existing pub/sub tuple based on the subscription information and a second element including information for obtaining second content from the identified content provider; and
providing the generated pub/sub message to a pub/sub service for providing the first content and second content to a pub/sub principal pursuant to a subscription to the mashup pub/sub tuple.
